(19) United States
(12) Patent Application Publication
(10) Pub. No.: US 2010/0299218 A1
(43) Pub. Date: Nov. 25, 2010

(54) METHOD AND APPARATUS OF PROVIDING DISCOVERY AND PAYMENT FOR ONLINE COMMERCE

(75) Inventors: Ville Aarni, Veikkola (FI); Miikka Sainio, Kerava (FI); Niklas Von Knorring, Helsinki (FI); Dmitry Kolesnikov, Vantaa (FI); Atte Lahtiranta, Bedford, MA (US)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/468,793

(22) Filed: May 19, 2009

(51) Int. Cl. G06Q 30/00; G06K 5/00

(52) U.S. Cl. 705/26; 235/380

(57) ABSTRACT

An approach is provided for discovering and paying for items in online commerce. A discovery application is launched to display one or more items available for purchase. Items that are selected for purchase are then transmitted to a payment application that is independent of the discovery application to obtain payment for the selected items.

### BACKGROUND

Wireless (e.g., cellular) service providers and device manufacturers are continually challenged to deliver value and convenience to consumers by, for example, providing compelling network services. One area of development has been on enhancing the security of online commerce conducted using mobile devices. More specifically, service providers and manufacturers face the challenge of protecting the security of information such as user identification and passwords, payment information for online commerce services, personal information for registering with certain services, etc. Security measures used to protect such information can be costly and resource intensive to implement particularly in a mobile environment.

### SOME EXAMPLE EMBODIMENTS

Therefore, there is a need for an approach for efficiently and securely discovering and paying for items in online commerce.

According to one embodiment, a method comprises initiating launching of a discovery application to display one or more items available for purchase. The method also comprises receiving input from a user for selecting one or more of the items to purchase using the discovery application. The method further comprises initiating transmission of one or more identifiers associated with each selected item from the discovery application to a payment application that is executed using a runtime module common to the discovery application. The payment application is used to obtain pricing information and a payment for the selected items independently of the discovery application.

According to another embodiment, an apparatus comprising at least one processor, and at least one memory including computer program code, the at least one memory and the computer program code configured to, with the at least one processor, cause the apparatus to initiate launching of a discovery application to display one or more items available for purchase. The apparatus is also caused to receive input from a user for selecting one or more of the items to purchase using the discovery application. The apparatus is further caused to initiate transmission of one or more identifiers associated with each selected item from the discovery application to a payment application that is executed using a runtime module common to the discovery application. The payment application is used to obtain pricing information and a payment for the selected items independently of the discovery application.

According to another embodiment, a computer-readable storage medium carrying one or more sequences of one or more instructions which, when executed by one or more processors, cause an apparatus to initiate launching of a discovery application to display one or more items available for purchase. The apparatus is also caused to receive input from a user for selecting one or more of the items to purchase using the discovery application. The apparatus is further caused to initiate transmission of one or more identifiers associated with each selected item from the discovery application to a payment application that is executed using a runtime module common to the discovery application. The payment application is used to obtain pricing information and a payment for the selected items independently of the discovery application.

According to yet another embodiment, an apparatus comprises means for initiating launching of a discovery application to display one or more items available for purchase. The apparatus also comprises means for receiving input from a user for selecting one or more of the items to purchase using the discovery application. The apparatus further comprises means for initiating transmission of one or more identifiers associated with each selected item from the discovery application to a payment application that is executed using a runtime module common to the discovery application. The payment application is used to obtain pricing information and a payment for the selected items independently of the discovery application.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of discovering and paying for items in online commerce, according to one embodiment;

FIG. 2 is a diagram of the components of a runtime module including a discovery application and a payment application, according to one embodiment;

FIG. 3 is a flowchart of a process for discovering items for purchase using a discovery application, according to one embodiment;

FIG. 4 is a flowchart of a process for paying for items using a payment application, according to one embodiment;

FIG. 5 is a flowchart of a process for using a web runtime module including a discovery application and a payment application, according to one embodiment;

FIGS. 6A and 6B are diagrams of user interfaces utilized in the processes of FIGS. 3-5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile station (e.g., handset) that can be used to implement an embodiment of the invention.

### DESCRIPTION OF PREFERRED EMBODIMENT

A method and apparatus for discovering and paying for items online are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described herein with respect to discovering and paying for items in online commerce on a mobile device, it is contemplated that the approach described herein may be used with other devices capable of displaying purchasing information including, for example, a fixed device such as a desktop computer, communication terminal, and the like.

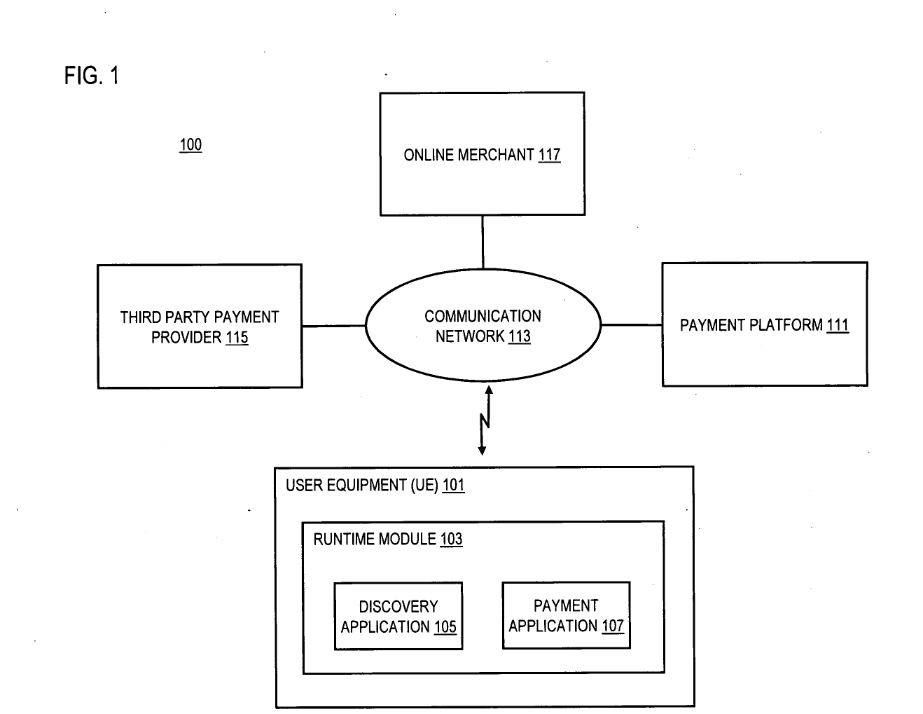

FIG. 1 is a diagram of a system capable of discovering and paying for items in online commerce, according to one embodiment. As previously discussed, services providers and manufacturers face the challenge of providing a secure environment to support online commerce on mobile devices. In particular, service providers are developing mechanisms for safeguarding the sensitive information (e.g., personal and financial information) that is often required of users to complete online commerce transactions. Moreover, it is noted that the industry as a whole recognizes that information security is critical to maintaining the growth of online commerce. Accordingly, to promote greater and continued adoption of online commerce, the online commerce industry, from service providers to payment processors, has agreed at great expense and effort to develop standards for information and data security that underlie the various services and features of online commerce.

One such standardization effort is the Payment Card Industry Data Security Standard (PCI DSS). The PCI DSS is designed to protect user credit card and other financial account information when used in computer systems that support all forms of commerce including, for instance, online commerce. More specifically, the PCI DSS provides standards comprising six broad categories: (1) standards for building and maintaining a secure network for supporting credit card transactions, e.g., standards for firewall configuration and related security parameters; (2) standards for protecting credit card data, e.g., standards for storage, encryption, and transmission of information related to credit card account holders; (3) standards for maintaining a security vulnerability management program, e.g., standards for developing and maintaining secure systems and applications for credit card transactions; (4) standards for implementing strong access control measures, e.g., standards for restricting access to credit card holder information; (5) standards for regularly monitoring and testing networks, e.g., standards for monitoring network access to credit card holder information and standards for regularly testing security systems and processes; and (6) standards for maintaining an information security policy, e.g., standards for maintaining a policy to address information security (see the “Payment Card Industry (PCI) Data Security Standard: Requirements and Security Assessment Procedures,” Version 1.2, October 2008, incorporated herein by reference in its entirety). The goal of the PCI DSS is to maintain the security of credit card account information as the information passes through commerce. In this way, the PCI DSS can be used to reduce fraud and encourage consumer confidence in online commerce.

In addition to the PCI DSS which applies to all members of the industry that use credit card information, the Payment Card Industry has also developed standards for vendors of payment applications supporting credit card, transactions titled the PCI Payment Application Data Security Standard (PA-DSS). The PA-DSS extends the requirements of the PCI DSS to vendors of payment applications who themselves may not store or process credit card information, but nonetheless create systems that allow their clients to store and process credit information (see the “Payment Card Industry (PCI) Payment Application Data Security Standard: Requirements and Security Assessment Procedures,” Version 1.2, October 2008, incorporated herein by reference in its entirety). In any case, a developer of applications to support online commerce payments could be subject to PCI DSS, PA-DSS, or both.

To be PCI DSS or PA-DSS compliant, the application developer adheres to the standards for ensuring and regularly testing security of online commerce applications described in the above referenced documents. However, compliance with the standards can be costly and resource intensive to maintain because of the extensive testing and monitoring requirements. At the same time, it is noted that online commerce applications typically include both a discovery component (e.g., a component to enable the user to find items of interest) and a payment comment (e.g., a component for accepting payment for the items of interest). Traditionally, these two components are included in one application (e.g., one application provides for discovery and payment of items available for purchase) even though only the payment portion of the application deals directly with credit card account information. Accordingly, the entire application would be subject to the PCI DSS or PA-DSS. In other words, the discovery portion of the online commerce application would be subject to the PCI DSS or PA-DSS because of its integration with the payment component even though the discovery portion does not specifically deal with credit card information at all. Enforcing the PCI DSS or PA-DSS to the entire application can greatly increase the cost of compliance.

To address this problem, a system 100 of FIG. 1 separates the discovery functions of online commerce into a discovery application that is run independently of the payment functions that are supported by a separate payment application. In this way, the discovery application need not undergo PCI DSS or PA-DSS compliance certification and monitoring because the application does not deal with credit card information. In other words, only the payment application is subject to the PCI-DSS or PA-DSS. As an additional advantage, the developer of the discovery application can make modifications to the discovery application without having to recertify the modified discovery application under PCI-DSS or PA-DSS. Without separating the discovery and payment applications, a modification to the discovery functions would subject the entire application to recertification even if the payment components were not changed in any way. In one embodiment, to provide a more consistent and coherent user experience, the discovery application and the payment application are run in a common runtime module to provide a discovery and payment user experience that is seamless to the user even though the user experience is provided by two independent and separate applications (e.g., the discovery application and the payment application).

As shown in FIG. 1, the system 100 comprises a user equipment (UE) 101 including a runtime module 103 comprising a discovery application 105 and a payment application 107. In one embodiment, the runtime module 103 is a web runtime or a secure web runtime. As used herein, the term “web runtime” is, for instance, a lightweight application framework created using standard web technology such as HyperText Markup Language (HTML), Cascading Style Sheets (CSS), JavaScript®, and the like. By way of example, web runtime is an extension of the WebKit® web browser engine provided by the WebKit Open Source Project. Web runtime technology enables small applications (e.g., “widgets”) to be easily distributed and installed. Applications using web runtime technology can be run either online (e.g., with web connectivity) or offline. A secure web runtime is a web runtime configured to use one or more cryptographic protocols (e.g., Secure Sockets Layer (SSL) or Transport Layer Security (TLS)) to provide protection against potential interception and eavesdropping of the transported data.

In one embodiment, the discovery application 105 is an application for browsing, searching, and finding items available for purchase over an online commerce site (e.g., a mobile application store). The payment application 107 is an application for pricing the items selected using the discovery application 105 and obtaining payment for the items based on the pricing information. By way of example, the discovery application 105 and the payment application 107 can be implemented as separate widgets within the runtime module 103.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). As shown in FIG. 1, the UE 101 has connectivity to a payment platform 111 over the communication network 113. In one embodiment, the payment platform 111 is operated by a service provider (not shown) to handle payments, credit card data, debiting of financial accounts, and clearance of financial transactions. For example, the payment application 107 interacts with the payment platform 111 to obtain payments for items selected by a user for purchase. The UE 101 also has connectivity to a third party payment provider 115. By way of example, the third party payment provider may perform the services of the payment platform 111 if the payment platform 111 is not present. In other embodiments, the third party payment provider may provide authorizations (e.g., authorization of credit card payments) for payments obtained by the payment application 107 and/or the payment platform 111. The UE 101 also has connectivity to one or more online merchants 117 through the communication network 113. Typically, the online merchants 117 provide a range of items available for purchase. The online merchants 117 may also include content providers or other service providers (not shown) with access to the communication network 113.

By way of example, the communication network 113 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

In certain embodiments, the UE 101, the payment platform 111, the third party payment provider 115, and the online merchant 117 communicate with each other and with other components of the communication network 113 using well known, new or still developing protocols. In this context, a protocol includes a set of rules defining how the network nodes within the communication network 113 (e.g., UE 101, payment platform 111) interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

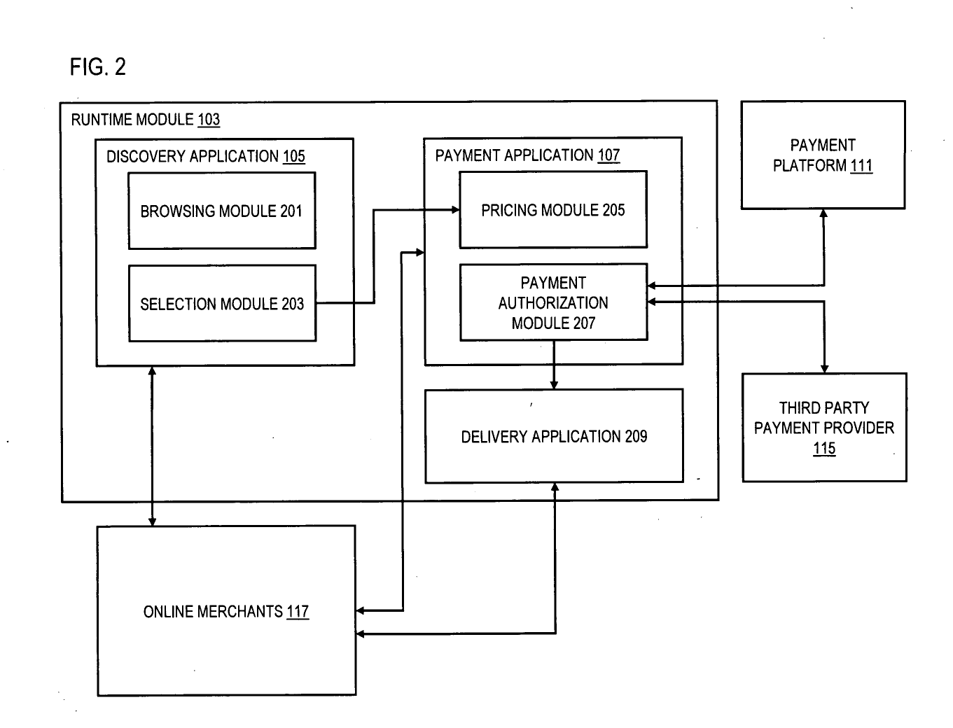

FIG. 2 is a diagram of the components of a runtime module including a discovery application and a payment application, according to one embodiment. By way of example, the runtime module 103 includes one or more components for discovering and paying for items in online commerce. It is contemplated that the functions of these components may be combined in one or more components or performed by other components of equivalent functionality. In this embodiment, the runtime module 103 includes the discovery application 105. In turn, the discovery application 105 includes a browsing module 201 and a selection module 203. The browsing module 201 interacts with the online merchant 117 to enable the user to view information on items available for purchase from the online merchant 117. It is contemplated that the browsing module 201 supports functions for browsing (e.g., scrolling through a list of all items, items in a certain category, recommended items, etc.) and searching (e.g., using a query or search function) for items of interest from the online merchant 117. In one embodiment, the browsing module 201 presents items in one or more categories to facilitate browsing. For example, one category comprises a recommended listed of items based on user preferences or on the purchasing history of the user. The categories or items presented to the user may also be based on a context (e.g., location, time, calendar) associated with the user. As an example, if the user is browsing for items during close to the birthday of the user's mother, the context may indicate that the user is searching for a gift. In this case, the browsing module 201 may recommend items appropriate for such a gift. After the user finds one or more items of interest, the selection module 203 enables the user to specify what items the user wishes to purchase. For example, the selection module 203 enables the user to designate one or more items to place in a virtual “shopping cart” for purchase. The selection module 203 then transmits the selections to the payment application 107 for processing. The transmission may include, for instance, an identifier associated with each of the selected items so that the payment application 107 can obtain the corresponding pricing information and a payment based on the pricing.

In one embodiment, the payment application 107 includes a pricing module 205 and a payment authorization module 207. By way of example, the pricing module 205 receives the identifiers associated with the user's selections and interacts with the corresponding online merchant 117 to obtain the pricing information for the items. The pricing module 205 creates and calculates an invoice or other similar billing summary including, for instance, the total price for the user's selections, and forwards the information to the payment authorization module 207. The payment authorization module 207 interacts with the payment platform 111 and/or the third party payment provider 115 to obtain payment for the determined amount. For example, the payment authorization module 207 can direct the user to a secure web page via a browser application to initiate payment. In one embodiment, the user may also initiate payment using a premium SMS message, whereby the service provider, for instance, directly bills the user's telephone account for the amount corresponding to the premium SMS message. It is contemplated that the user may specify any form of payment (e.g., credit card payment, phone billing, operator billing, third party billing). By way of example, the form of payment may be automatically determined based on the type of device of the user's device (e.g., a mobile phone with premium SMS capability) or based on user preference. In another embodiment, the payment application 107 and/or the payment platform 111 may remember the user's last-used or preferred form of payment and may suggest that form of payment for the user's subsequent purchases.

In one embodiment, the payment authorization module 207 can request specific authorization and confirmation for a payment from either the payment platform 111 and/or the third party payment provider 115. Once the payment is authorized and confirmed, the payment authorization module 207 directs the delivery application 209 to initiate delivery of the purchased items. For example, if the purchased items are deliverable by download, the delivery application 209 interacts with the online merchant 117 to initiate delivery of purchased items to the user via, for instance, a secure download. In one embodiment, a record of the user's purchased items and corresponding download link may be stored in the user's web account with the online merchant 117. The user can access the secure download and/or the web account using, for instance, a user name and password combination. It is contemplated that the delivery application 209 may use any mechanism (e.g., biometric security, address filtering, etc.) to ensure that only authorized users may access the secure download and/or corresponding web account. Although the delivery application 209 is shown as a separate application within the runtime module 103, it is contemplated that the delivery application 209 can be a component in any other component of the system 100 including the discovery application 105, payment application 107, payment platform 111, third party payment provider 115, online merchant 117, or a combination thereof.

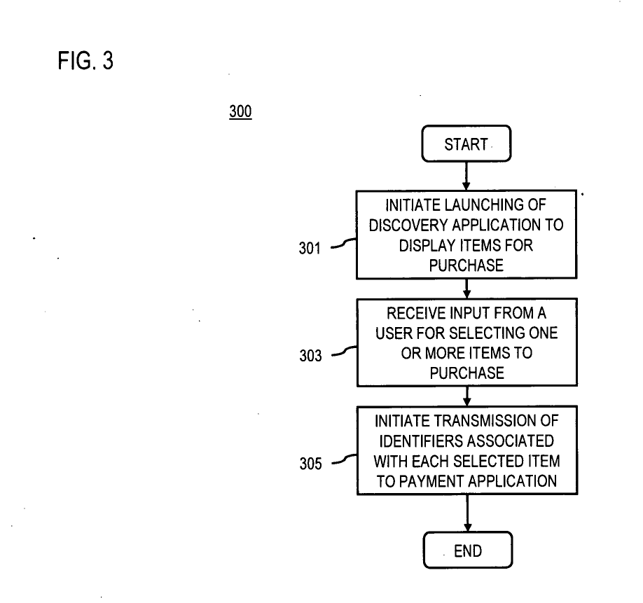

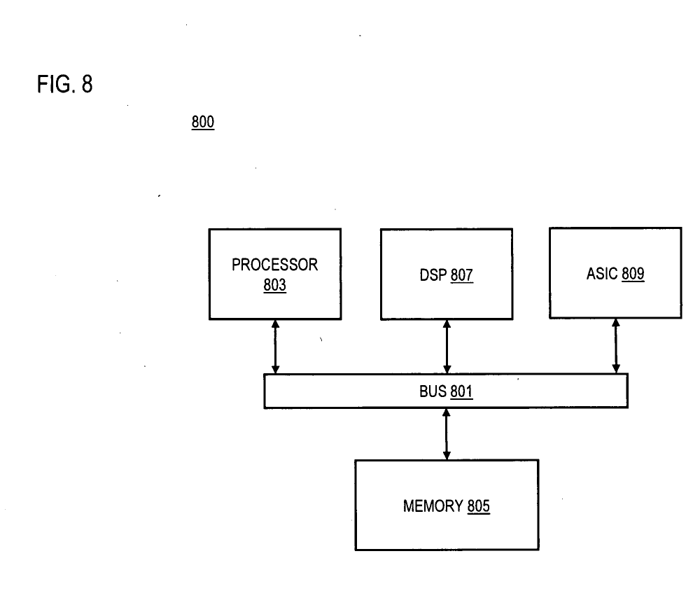

FIG. 3 is a flowchart of a process for discovering items for purchase using a discovery application, according to one embodiment. In one embodiment, the process 300 is performed in the runtime module 103 and is implemented in, for instance, a chip set including a processor and a memory as shown FIG. 8. In step 301, the runtime module 103 (e.g., a secure web runtime) initiates launching of the discovery application 105 to display one or more items available for purchase from, for instance, the online merchant 117. The discovery application 105, for instance, interacts with an application programming interface (API) (not shown) of the online merchant 117 to obtain information on items available for purchase. By way of example, the information may include a description, pictures, pricing, availability, etc. related to items available for purchase. These items may include applications, services, content, items, and other goods. In one embodiment, the API corresponding to the online merchant 117 may be either a public or a private API. In this example, public APIs are those released publicly by the online merchant 117 for accessing publicly available functions or data provided by the merchant 117. Private APIs are those provided, for instance, for granting private access to certain functions and data of the online merchant 117. For example, private APIs are typically exchanged through mutual agreement between the online merchant 117 and the developer of the discovery application 105.

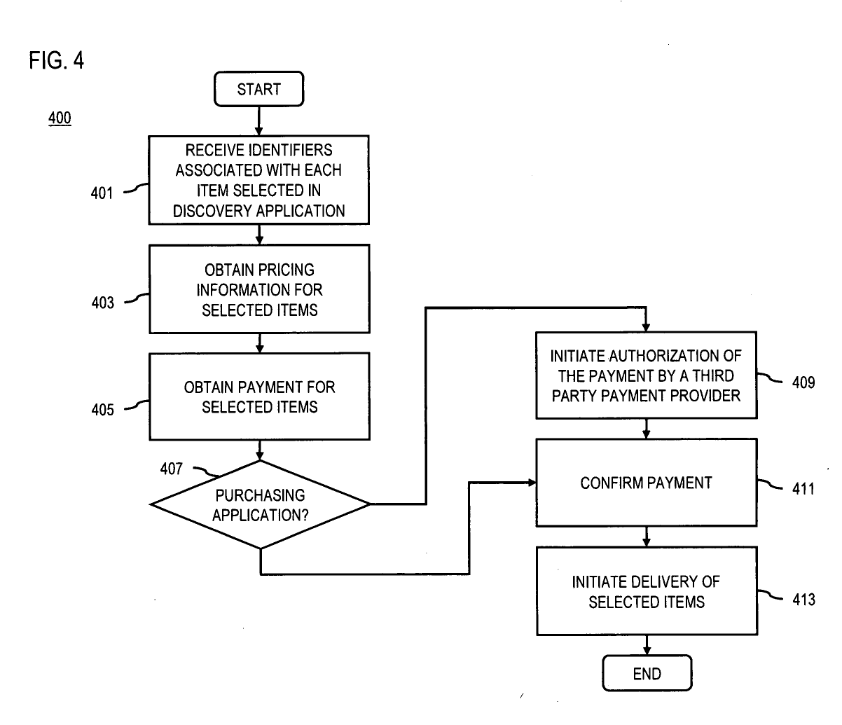

In this example, the discovery application 105 may be initiated by user request or by another application or process (not shown) of the UE 101. The discovery application 105 then receives input from the user for selecting one or more of the items displayed by the discovery application 105 for purchase (step 303). As discussed with respect to FIG. 2, selection of the one or more items may include placing the item in a virtual shopping basket. It is contemplated that the discovery application may use another mechanism (e.g., setting a flag, creating a list) for designating one or more items for purchase. After the user completes selection of one or more items, the discovery application 105 initiates transmission (e.g., forwards) of identifiers associated with the one or more selected items to the payment application 107 running in the runtime module 103 common to the discovery application 105 (step 305). It is contemplated that the discovery application 105 may also transmit any other information (e.g., description, picture, price, etc.) associated with the selected items that is compliant with PCI DSS or PA-DSS. In one embodiment, the payment application 107 is launched within the runtime module 103 when the discovery application 105 is launched. As discussed previously, the discovery application 105 and the payment application 107 are separate and independent applications within the runtime module 103. In particular, the discovery application does not access, store, or process any information related to credit card account information, nor does the payment application 107 share any such information with the discovery application 105. The process then continues as described with respect to FIG. 4 below.

FIG. 4 is a flowchart of a process for paying for items using a payment application, according to one embodiment. In one embodiment, the process 400 is performed in the runtime module 103 and is implemented in, for instance, a chip set including a processor and a memory as shown FIG. 8. In step 401, the payment application 107 running within the runtime module 103 receives identifiers associated with each item selected by the user using the discovery application 105 as described with respect to FIG. 3. The payment application 107 then uses the identifiers or other transmitted information to obtain pricing information for the selected items from, for instance, the corresponding online merchant 117 (step 403). By way of example, the payment application 107 obtains the pricing information using an API provided by the online merchant 117 as described with respect to FIG. 3. The payment application 107 uses the pricing information to calculate an amount of payment to collect for the selected services.

After calculating the amount, the payment application 107 obtains payment for the selected services using, for instance, the payment platform 111 and/or the third party payment provider 115 (step 405). If the payment from a third party source (e.g., a credit card provider) (step 407), the payment application 107 initiates authorization of the payment for the selected items from the third party payment provider 115 (step 409). For example, authorization may include validating that there are sufficient funds or credit to authorize the payment. Authorization may also include verifying that the order for the selected items is authentic and that an authorized party submitted the order. Next (or if no authorization was required from the third party payment provider 115), the payment application 107 confirms the authorization and/or receipt of payment (step 411). The confirmation, for instance, may include a confirmation code from the payment platform 111 and/or the third party payment provider 115. On receipt of the confirmation, the delivery application 209 initiates delivery of the selected items (step 413). For example, if the selected items are downloadable, the delivery application 209 initiates a secure download of the selected items to the user. It is contemplated that the delivery application 209 can deliver the selected items in a manner appropriate to the items or as requested by the user. For example, if the item is a tangible good, the delivery application 209 interacts with the online merchant 117 to arrange for physical delivery.

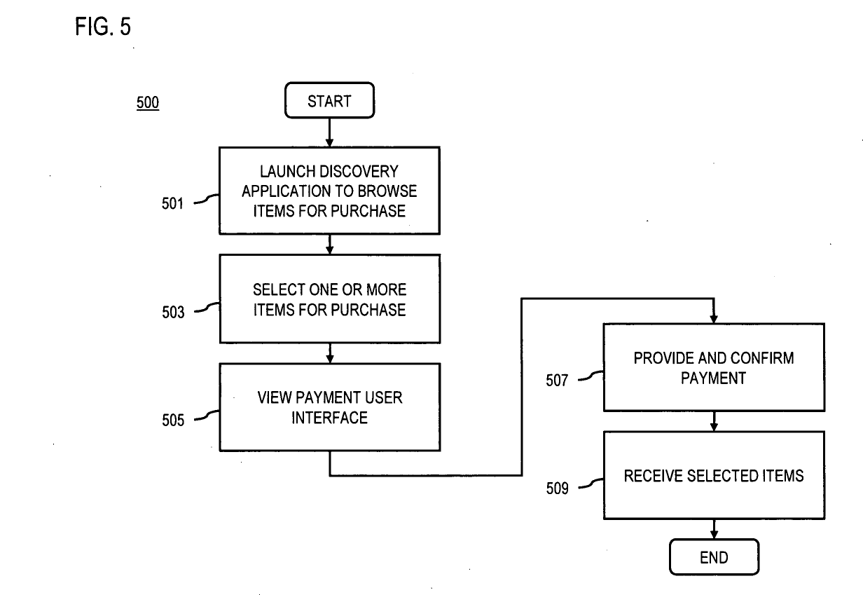

FIG. 5 is a flowchart of a process for using a web runtime module including a discovery application and a payment application, according to one embodiment. In step 501, the user launches the discovery application 105 to browse for items to purchase. For example, the user may launch the discovery application 105 by selecting the corresponding icon representing the application 105 on the UE 101. In addition or alternatively, the discovery application 105 may be selected to run as a widget on the user's home screen on the UE 101. On launching the discovery application 105, the payment application 107 is also, for instance, simultaneously launched within the same runtime module 103 as the discovery application 105. The user then proceeds to browse and select items for purchase using the discovery application 105 (step 503). After selecting one or more items, the user selects a “check out” option on the UE 101 to view the payment user interface provided by the payment application 107 (step 505). Because the discovery application 105 and the payment application 107 are running in the same runtime module 103, the transition between the discovery application 105 and the payment application 107 is, for instance, seamless and appears to the user as if the user is using one application. The user provides and confirms payment using the payment interface of the payment application 107 (step 507). It is contemplated that the payment may be made manually (e.g., the user enters account information, delivery instructions, etc.) or automatically (e.g., by a near field communication tag, by biometric payment authorization). After the payment application 107 completes authorization and confirmation of payment, the user receives the selected items (step 509).

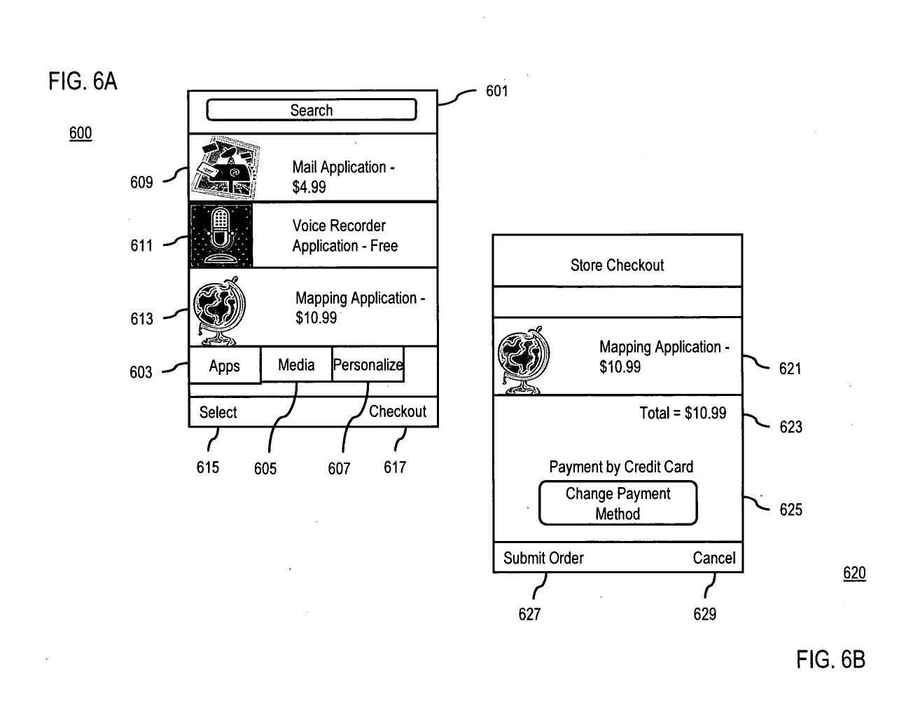

FIGS. 6A and 6B are diagrams of user interfaces utilized in the processes of FIGS. 3-5, according to various embodiments. FIG. 6A depicts a user interface 600 for browsing items available for purchase using the discovery application 105. In this example, the user has selected to browse an online store using a mobile device (e.g., the UE 101). As shown, the user may search for a specific mobile application using the search bar 601. The user may also simply browse available applications by, for instance, scrolling through a list associated with categories designated, for instance, by a tag 603 for applications, a tag 605 for media (e.g., music, movies, podcasts, channels), and a tag 607 for personalizing the user's device (e.g., ringtones, wallpapers, themes). In this example, the user has selected the applications tag 603. Accordingly, the user interface 600 displays a selection of three applications available for the user to purchase: (1) a mail application 609, (2) a voice recorder application 611, and a (3) mapping application 613. In one embodiment, the discovery application 105 displays an icon associated with the application, a description, and a price. The user may click on the “Select” command 615 to place an application in a virtual shopping cart. Once the selection is complete, user may select the “Checkout” command 617 to display the payment user interface provided by the payment application 107.

FIG. 6B depicts a user interface 620 for displaying a user interface screen 620 for obtaining payment for the items selected for purchase. In this example, the payment application 107 provides the user interface 620 independently of the discovery application 105. As shown, the user has selected to purchase the mapping application 607 as displayed in the purchase summary section 621. The user interface 620 also displays a total amount 623 for the user's order. In this case, the user has selected only one item to purchase. Accordingly the total amount 623 is equal to the price of the mapping application 607 (e.g., $10.99). In one embodiment, the user interface 620 displays the method of payment 625 and provides an option to change the method. As depicted in FIG. 6B, the default payment method is credit card. This default payment method is determined, for instance, by user preference or by the last form of payment selected by the user. The user may change the form of payment to any other type supported by the payment application 107 and/or the payment platform 111 (e.g., telephone account billing, operator billing, etc.). If the user is satisfied with the order, the user selects the “Submit Order” command 627 to submit the payment for authorization and request delivery of the selected application. If the user wishes to cancel the order, the user selects the “Cancel” command 629.

The processes described herein for providing discovering and paying for items in online commerce may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

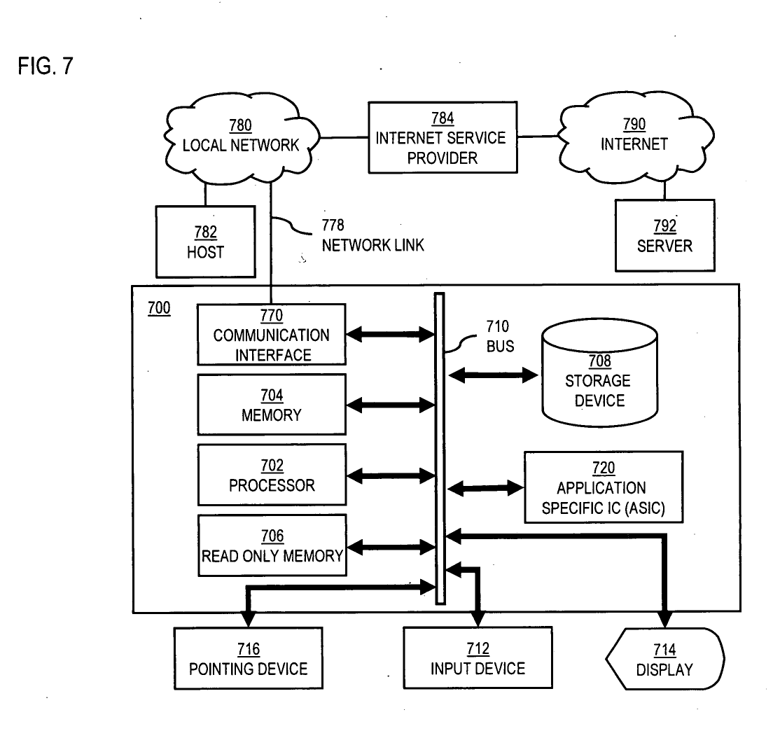

FIG. 7 illustrates a computer system 700 upon which an embodiment of the invention may be implemented. Computer system 700 is programmed (e.g., via computer program code or instructions) to discover and pay for items in online commerce as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to discover and pay for items in online commerce. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for discover and pay for items in online commerce. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for discovering and paying for items in online commerce, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 113 for discovering and paying for items in online commerce by the UE 101.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 8 illustrates a chip set 800 upon which an embodiment of the invention may be implemented. Chip set 800 is programmed to discover and pay for items in online commerce as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to discover and pay for items in online commerce. The memory 805 also stores the data associated with or generated by the execution of the inventive steps.

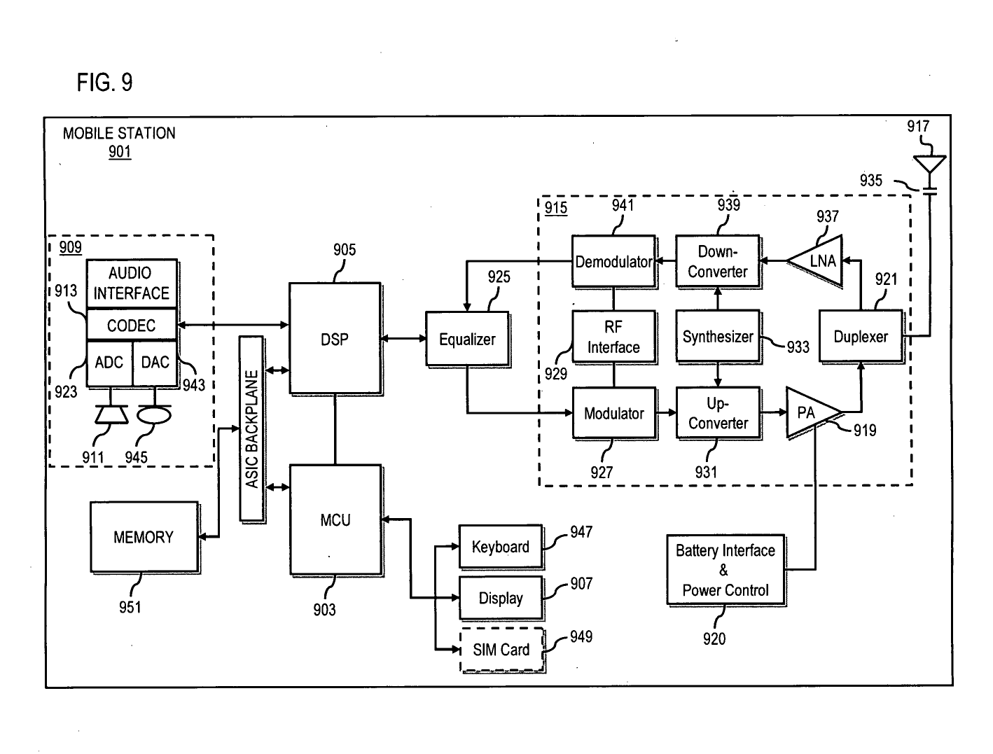

FIG. 9 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903-which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to discover and pay for items in online commerce. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
initiating launching of a discovery application to display one or more items available for purchase;
receiving input from a user for selecting one or more of the items to purchase using the discovery application; and
initiating transmission of one or more identifiers associated with each selected item from the discovery application to a payment application that is executed using a web runtime module common to the discovery application,
wherein the payment application is used to obtain pricing information and a payment for the selected items independently of the discovery application.

2. A method of claim 1, wherein the payment application is compliant with Payment Card Industry Data Security Standard (PCI DSS) or with Payment Card Industry Payment Application Data Security Standard (PCI PA-DSS).

3. A method of claim 1, wherein the web runtime module is a secure web runtime module.

4. A method of claim 1, further comprising:
using the payment application to initiate authorization of the payment for the selected items by a third party payment provider.

5. A method of claim 4, further comprising:
confirming the authorization of the payment; and
initiating delivery of the selected items based on the confirmation.

6. A method of claim 1, wherein the payment is obtained using a browser application or a premium short message service (SMS) message.

7. A method of claim 1, wherein the discovery application, the payment application, or both operate over a radio network.

8. An apparatus comprising:
at least one processor; and
at least one memory including computer program code,
the at least one memory and the computer program code configured to, with the at least one processor, cause the apparatus to perform at least the following,
initiate launching of a discovery application to display one or more items available for purchase,
receive input from a user for selecting one or more of the items to purchase using the discovery application, and
initiate transmission of one or more identifiers associated with each selected item from the discovery application to a payment application that is executed using a web runtime module common to the discovery application,
wherein the payment application is used to obtain pricing information and a payment for the selected items independently of the discovery application.

9. An apparatus of claim 8, wherein the payment application is compliant with Payment Card Industry Data Security Standard (PCI DSS) or with Payment Card Industry Payment Application Data Security Standard (PCI PA-DSS).

10. An apparatus of claim 8, wherein the web runtime module is a secure web runtime module.

11. An apparatus of claim 8, wherein the apparatus is further caused to:
use the payment application to initiate authorization of the payment for the selected items by a third party payment provider.

12. An apparatus of claim 11, wherein the apparatus is further caused to:
confirm the authorization of the payment; and
initiate delivery of the selected items based on the confirmation.

13. An apparatus of claim 8, wherein the payment is obtained using a browser application or a premium short message service (SMS) message.

14. An apparatus of claim 8, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

15. A computer-readable storage medium carrying one or more sequences of one or more instructions which, when executed by one or more processors, cause the one or more processors to at least perform the following steps:
initiating launching of a discovery application to display one or more items available for purchase;
receiving input from a user for selecting one or more of the items to purchase using the discovery application; and
initiating transmission of one or more identifiers associated with each selected item from the discovery application to a payment application that is executed using a web runtime module common to the discovery application,
wherein the payment application is used to obtain pricing information and a payment for the selected items independently of the discovery application.

16. A computer-readable storage medium of claim 15, wherein the payment application is compliant with Payment Card Industry Data Security Standard (PCI DSS) or with Payment Card Industry Payment Application Data Security Standard (PCI PA-DSS).

17. A computer-readable storage medium of claim 15, wherein the web runtime module is a secure web runtime module.

18. A computer-readable storage medium of claim 15, wherein the apparatus is caused to further perform:
using the payment application to initiate authorization of the payment for the selected items by a third party payment provider.

19. A computer-readable storage medium of claim 18, wherein the apparatus is caused to further perform:
confirming the authorization of the payment; and
initiating delivery of the selected items based on the confirmation.

20. A computer-readable storage medium of claim 15, wherein the payment is obtained using a browser application or a premium short message service (SMS) message.
